(19) United States
(12) Patent Application Publication
(10) Pub. No.: US 2005/0223639 A1
(43) Pub. Date: Oct. 13, 2005

(54) Plant container base with root-directing channels

(76) Inventor: Carl E. Whitcomb, Stillwater, OK (US)

Correspondence Address: STREETS & STEELE, 13831 NORTHWEST FREEWAY, SUITE 355, HOUSTON, TX, 77040, US

(21) Appl. No.: 10/823,379

(22) Filed: Apr. 13, 2004

(51) Int. Cl. A01G 9/02

(52) U.S. Cl. 47/65.6

(57) ABSTRACT

A base for various plant containers, including containers having flexible sidewall panels with protuberances that retain the base and containers that integrate the base into a unitary container structure. The base includes an upper surface that intercepts plant roots to prevent root circling and, preferably also prevents a perched water table. The upper surface of the base may be convex and includes a plurality of channels that direct the roots in a generally radial direction. Accordingly, roots are redirected radially and prevented from circling. The roots may also be directed radially into air-root-pruning protuberances in the panel. The base may have a perimeter resting on, in or between protuberances of an air-root-pruning panel or specific elements, whether protuberances or not, in the panel to retain the base in position relative to the sidewall panel.

### BACKGROUND OF THE INVENTION

1. Field of the Invention

This invention relates generally to containers for growing plants. More particularly, the invention relates to the design of a container base for enhancing the health of plant roots.

2. Background of the Related Art

Transplantable plants for use in landscaping, such as trees and shrubs, are generally initially grown in conventional smooth-walled containers made of plastic, steel or other materials. However, when a root contacts the inner sidewall or base of a smooth walled container the root is deflected and follows the curvature of the container. The result is the production of only a few secondary branch roots. In some cases, roots make several revolutions around the container, mostly at the bottom, forming a coil. The result is an abnormal root system that does a poor job of establishing and supporting the plant following transplanting. Impaired root development following transplanting restricts growth of any species. Poor root development and anchorage is especially detrimental to trees that grow to considerable height and where stresses from wind, ice and snow are exaggerated.

Whitcomb (U.S. Pat. Nos. 4,442,628; 4,510,712; 4,753,037; 4,939,865; and 5,557,886) teaches various container sidewall designs with strategic placement of openings in above ground containers to accomplish air-root-pruning (root tip dehydration pruning) to stop root circling and stimulate root branching. These containers work by guiding an actively growing root tip, which is white soft tissue, into an opening where the root tip dehydrates, dies and is, therefore, effectively pruned. The effect on the root system is the same as when a plant is pruned above ground, for example, to make a hedge. Each time the plant is pruned above ground, secondary branches form back as far as about four inches from the point of pruning and through a succession of prunings, a dense plant hedge or screen can be created. An identical phenomenon is seen to occur with roots for the same physiological reasons. Such air-pruning container designs have been successful and are currently sold in various sizes (available under the RootMaker™ and RootBuilder™ trademarks from RootMaker Products Co., LLC of Huntsville, Ala.).

Van Wingerden (U.S. Pat. No. 5,131,185), Lawton (U.S. Pat. No. 5,099,607) and Henry (U.S. Pat. No. 5,241,784) also teach air-root-pruning by container sidewall design. Butler (U.S. Pat. No. 5,937,577) teaches air-root-pruning as a result of constructing a container out of chicken wire and lining the inside with a woven polyester fabric. This design does accomplish air-root-pruning throughout the circumference of the container, but the salt accumulation due to the high loss of water to evaporation makes it less efficient in terms of conserving water. This design is generally only practical to use where irrigation water quality is good and humidity is high.

Whitcomb (U.S. Pat. No. 4,497,132) teaches that when root tips are trapped in a saw tooth-like recess as part of the container wall and cannot extend, root tips cease to grow and root branching results. Root circling is reduced and root branching is improved.

Most recently, Whitcomb (U.S. patent application Ser. No. 10/446,987, filed on May 28, 2003, incorporated herein by reference) discloses a panel for use as a container sidewall that has a plurality of outwardly extending protuberances that have a proximal opening with a center point that is above the center point of a distal opening. In this manner, the protuberance is shaped to guide root tips into the protuberance and avoid ricocheting or circling of roots. The use of this container sidewall produces a healthy root ball with lots of side branches and little or no root circling.

However, despite the many container sidewall designs available to improve the health of a plant in a container, there remains a need for a container having a base designed to promote the health of the roots by preventing root circling. There is also a need for a container that provides both a sidewall and a base that work together to promote healthy and abundant root growth without root circling. It would be desirable if the base could also improve water management. It would also be desirable if the base design could be adapted for use with flexible panels, prefabricated conventional containers, or incorporated into rigid, molded pots. Most desirably, the base would aid, improve or enhance air root pruning of the roots.

### SUMMARY OF THE INVENTION

The invention is a base for a plant container, the base having an upwardly facing surface with a plurality of radially directed channels. The upwardly facing surface is preferably free from obstructions to radial root growth. The base is preferably secured to a sidewall. The most preferred means for securing the base to the sidewall include receiving the base within at least one recess in the sidewall, supporting the base on at least one shoulder of the sidewall, or coupling the base to the sidewall with fasteners. It is also preferred for the radially directed channels extend into communication with openings in the sidewall suitable for air-root-pruning of roots directed through the channel.

One embodiment of the invention is a plant container comprising a sidewall having a plurality of shoulders, and a base supported on the shoulders, wherein the base has an upwardly facing surface with a plurality of radially directed channels. Optionally, the sidewall and the base are separable, such as where the sidewall is a flexible panel that is bent and fastened in a closed curvilinear shape, preferably to constrain displacement of the base. Preferably, the upwardly facing surface is convex, such a shape selected from conical, semispherical, elliptical, and irregular. For example, the convex surface may have a center that is between 1 and 2 inches higher than a perimeter. Preferably, the channels extend over more than half the distance between the center and the perimeter. Typically, the base will have a generally circular perimeter, which may optionally include a plurality of projections.

The base may be supported or constrained by a plurality of shoulders that are inwardly extending, outwardly extending, or combinations thereof. The shoulders may be dedicated shoulders or, more preferably, may be provided by a plurality of protuberances. Preferably, at least a portion of the protuberances will have a proximal opening in communication with a distal opening. In one embodiment, the base has a perimeter with a plurality of projections that extend into the plurality of protuberances through the proximal openings.

The channels are disposed to reduce or prevent root circling. Each of the channels has a sidewall that directs roots outwardly. The channels may have any beneficial depth (or similarly, channel sidewall height), but are preferably between 0.1 and 1 inches deep, more preferably between 0.15 and 0.75 inches deep, and most preferable between 0.25 and 0.5 inches deep. In one embodiment, the channels are deeper at a distal end than at a proximal end. However, in a preferred embodiment, the channels are disposed over the upwardly facing surface to direct roots toward a plurality of protuberances and optionally the channels may extend into the proximal openings of the protuberances. Optionally, the base may include a central dome or hump further directing roots outwardly.

In embodiments having a sidewall with a plurality of protuberances, the protuberances will preferably provide the plurality of shoulders to support or constrain the base. Various protuberances are suitable for this purpose, including, without limitation, inwardly extending protuberances that are typically closed and outwardly extending protuberances having a proximal opening in communication with a distal opening for air-root-pruning. A most preferred design includes outwardly extending protuberances having a lower profile with a substantially horizontal region that receives the projections.

In another embodiment, a plant container, comprises a base having an upwardly facing convex surface with a plurality of radially directed channels, and a container sidewall extending upward around the perimeter of the base, wherein the sidewall includes a hole adjacent the plurality of radially-directed channels.

In yet another embodiment, a base for inserting in a plant container comprises a disk having an upwardly facing surface including a plurality of radially directed channels, a deflecting element near a distal end of each channel, and a root-tip-trapping element, wherein the deflecting element directs roots against a wall of the container at an angle that causes the root to deflect off the wall and into the root-tip-trapping element. Preferably, the upwardly facing surface of the disk is convex.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a top view of a base for use in a container for growing plants.

FIG. 1B is a side view of the base of FIG. 1A.

FIG. 1C is a cross-sectional side view of the base of FIGS. 1A and 1B retained to an air-root-pruning panel formed into a container sidewall.

FIG. 2A is a top view of a second embodiment of a base for use in a container for growing plants.

FIG. 2B is a side view of the base of FIG. 2A.

FIG. 2C is a cross-sectional side view of the base of FIGS. 2A and 2B retained to an air-root-pruning panel formed into a container sidewall.

FIG. 2D is a partial perspective view of the inner surfaces of the container formed by the base and air-root-pruning panel of FIG. 2C.

FIG. 2E is a perspective view of the outer surfaces of the container formed by the base and air-root-pruning panel of FIG. 2C.

FIG. 3 is a side view of a third embodiment of a base for use in a container for growing plants.

FIG. 4 is a side view of a third embodiment of a base for use in a container for growing plants.

FIG. 5 is a cross-sectional side view of a base retained by special elements in a flexible panel forming a container sidewall.

FIG. 6A is a schematic cross-sectional side view of a container having a base that rests upon special elements formed by shoulders or knobs.

FIG. 6B is an inside face view of a lower section of the panel 42 from FIG. 6A.

FIG. 7 is a cross-sectional view of a conventional plant container having a base disposed in the bottom of the container.

FIG. 8 is a schematic top view of a base for use with a conventional smooth-walled plant container.

### DETAILED DESCRIPTION OF THE PREFERRED EMBODIMENTS

The present invention provides a base for a container used for growing plants. The base forms the floor of a container and supports and retains growth medium, such as soil, within the container. The base may be used in conjunction with various container sidewalls or panels, including flexible panels having protuberances that retain the base there between and rigid pots that integrate the base into a unitary container structure. The base includes an upper surface that intercepts plant roots and prevents the roots from circling. Preferably, the upper surface of the base is further designed to minimize a perched water table within the container. It should be recognized that the channels may be defined by the region between adjacent ridges or ribs.

In one embodiment, the base has a perimeter having a configuration that cooperates with protuberances of an air-root-pruning panel. Preferably, the base is retained by an air-root-pruning panel by wrapping and securing the flexible panel around the perimeter of the base. Accordingly, the base may rest on, in or between a plurality of inward extending protuberances; on, in or between a plurality of outward extending protuberances; or on, in or between some combination of inward extending and outward extending protuberances. Furthermore, the flexible panels may be designed with specific elements, whether protuberances or not, that cooperate with the perimeter of the base in order to retain the base in position relative to the container sidewall panel. Examples of specific elements include, without limitation, grooves, shoulders, holes, fasteners, and combinations thereof. Still, the base may be used in combination with, for example, other air-root-pruning panels or sidewalls, conventional pots, root-tip-trapping panels or sidewalls, and combinations thereof.

In yet another embodiment, the base may be secured, supported or integrated with a preformed container or container sidewall whether or not the sidewall provides air-root-pruning or not. For example, the base may be formed integrally with the sidewall as a unitary container in a single mold. It should be recognized from the foregoing embodiments, that the base has utility regardless of the sidewall type or attachment method. However, it is preferred that the sidewall provides for drainage of water out of the container at various points adjacent the perimeter edge of the base. Further still, the base may be laid on the base of a preformed container in order to prevent root circling along the bottom of the container. Most preferably, the preformed container will include drain holes or protuberances along the lower portion of the sidewall.

The base preferably can be assembled with a sidewall and disassembled from a sidewall at the point of use. In this manner storage and shipping volume can be minimized. Furthermore, a base can be provided as an optional part of the container. The rigidity of the base should be able to support the weight of the growth medium (including water and plant) when the edge of the base is supported by the sidewall. It is generally not necessary that the base have so much rigidity as to resist bending when the base is not secured within the sidewall.

The plurality of channels on the upper surface of the base are disposed in a radial pattern to prevent root circling along the bottom of the container. The upper surface is preferably also sloped downwardly from the center to the perimeter so that roots are directed outwardly toward the perimeter rather than inwardly toward the center. When the channels have a sloped surface, the roots extending into contact with the base are generally directed radially outward. The radial pattern of channels may be truly radial, more radial than transverse, or some combination thereof, such as curved channels.

The upper surface may be level, but is preferably sloped downwardly from the center to the perimeter. The slope may be at a constant angle or a changing angle, such as a curve. A particularly preferable slope is provided by a convex curve, such as a semicircular curve, an elliptical curve, or some other curvilinear shape. A most preferred slope is provided by a convex surface in combination with a central dome extending upward from the center of the convex surface. In this manner, even roots directed straight downward into contact with the center of the base will be unlikely to deflect back upward, but rather will be deflected outwardly and downwardly so that the roots will be directed radially. Preferably, these central roots are directed along the sloped surface of the channels and prevented from circling by the sidewalls of the channels. While the base may include holes therein, such as a drain hole or an air-root-pruning protuberance, this is generally less preferred and unnecessary because the convex shape will itself promote proper drainage without allowing grow downward into the soil beneath the container.

The upper surface of the base includes a plurality of channels that direct the roots in a generally radial direction. Each of the channels provides a sidewall that directs roots radially. Preferably; at least some of the channels will extend over more than half the distance from the center of the base to the perimeter of the base. However, it should be recognized that many channels of shorter length in communication with each other could be used to effectively accomplish the same result as longer channels. The channels may have the same or different lengths, may be disposed at the same or different angles relative to radial, and may be disposed at uniform or non-uniform angular spacing about the center of the base. However, it is preferred to have at least one channel every 15 to 25 degrees about a center point in order to reduce the opportunity for a root to become misdirected.

Where the container sidewall includes openings such as air-root-pruning elements, protuberances, or drain holes, the distal end of a channel will preferably be disposed or aligned to direct roots into an opening. This may be achieved by aligning the entire channel with the opening or including a deflecting curve at the distal end of the channel. Optionally, the channel may extend into an opening. The channels typically have sidewalls that are between 0.1 and 1 inches tall, preferably between 0.15 and 0.75 inches tall, and more preferably between 0.25 and 0.5 inches tall. In one embodiment, at least some of the directing member sidewalls are taller at the distal end than at the proximal end (near the center of the base). The cross-sectional profile of the channels may vary, including, for example, squares, rectangles, triangles, arches, and combinations thereof.

When the base is used in conjunction with a flexible sidewall panel, the panel is wrapped around the perimeter of the base to engage and support the perimeter of the base. The sidewall has a plurality of shoulders that support the base, wherein the shoulders may, for example, be shoulders dedicated for providing support, provided by the outer surface of an inwardly extending protuberance, provided by the inner surface of an outwardly extending protuberance, or some combination thereof. A particularly preferred protuberance has a proximal opening with a center that is positioned higher than the center of the distal opening when the panel is positioned upright. Optionally, the plurality of protuberances may have a lower profile with a substantially horizontal region that supports the base. When the base is supported by the inside surface of outwardly extending protuberances, it is preferred that the perimeter edge of the base include projections that extend outwardly into individual protuberances.

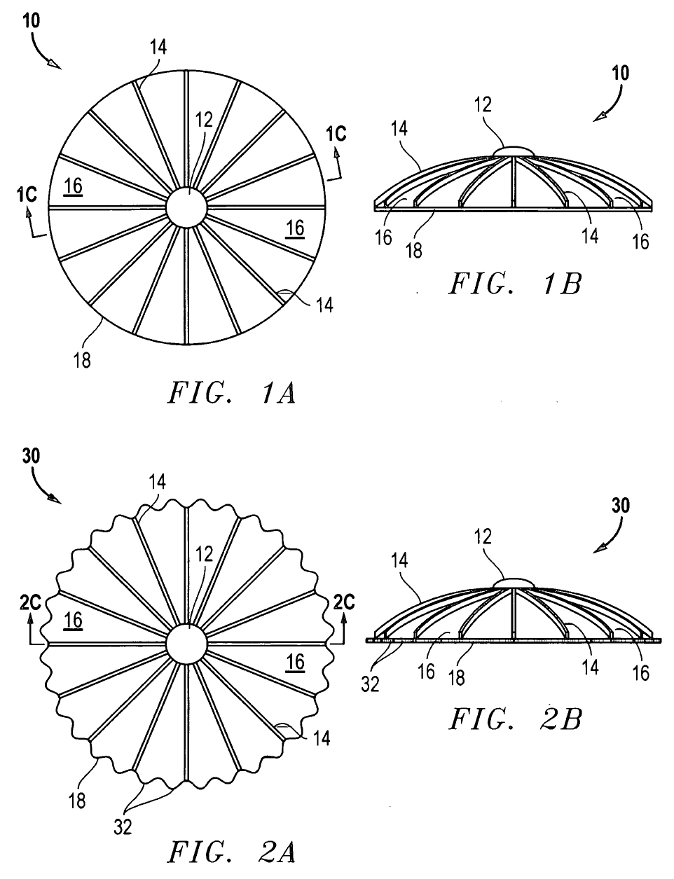

FIG. 1A is a top view of a base 10 for use in a container for growing a plant, most typically for the purpose of later transplanting the plant. The base 10 has a central dome 12 and a plurality of radial channels defined by the convex surface 16 between adjacent ribs 14 that extend from the central dome 12 to a perimeter 18.

FIG. 1B is a side view of the base 10 of FIG. 1A. The convex surface 16 is generally semi-circular and the central dome 12 has a steep slope with an apex.

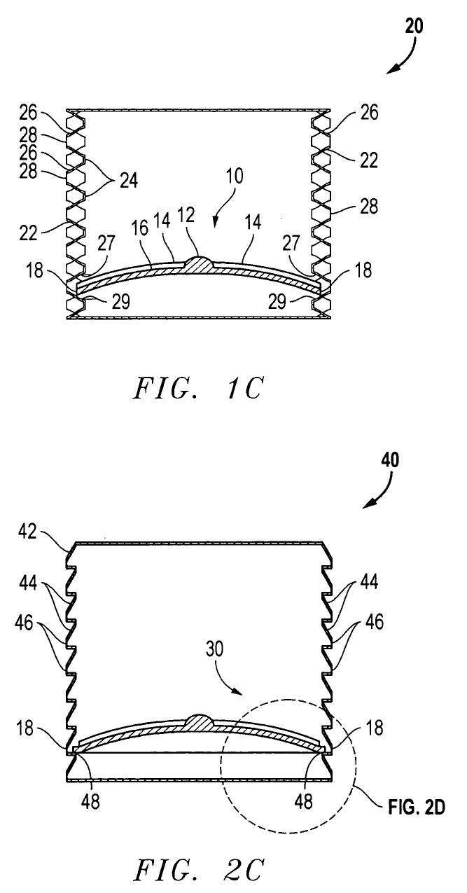

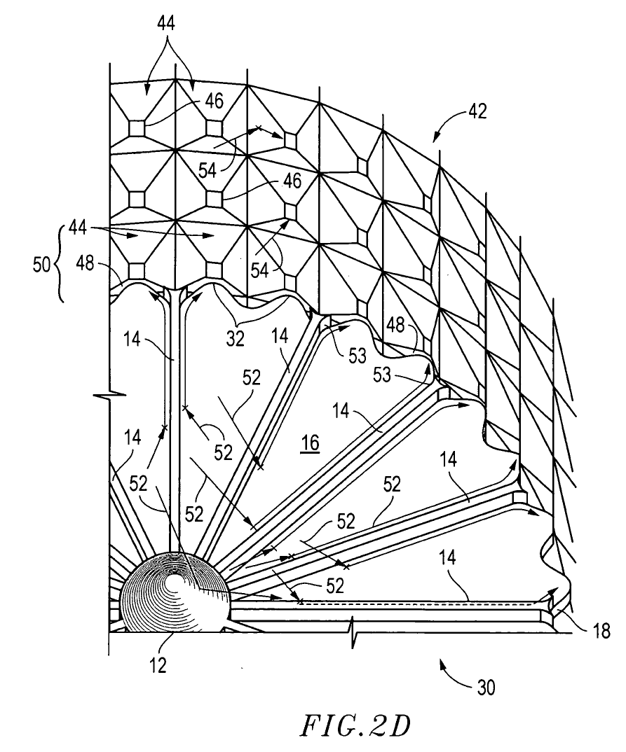

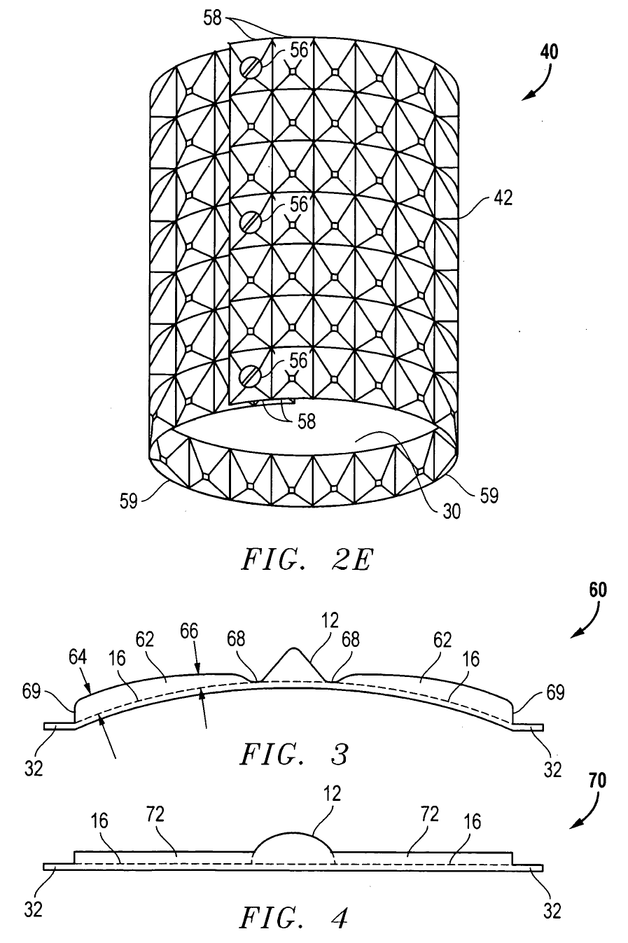

FIG. 1C is a cross-sectional side view of the base 10 of FIGS. 1A and 1B secured to an air-root-pruning panel 22 formed into a sidewall of a container 20. The panel 22 has a plurality of inwardly extending protuberances 24, typically without openings, and a plurality of outwardly extending protuberances 26 with openings 28 in the distal end of the protuberances 26. With this type of panel 22, the perimeter 18 of the base 10 is supported on the inside surface 29 of a row of the inwardly extending protuberances 24. As shown, the panel 22 will preferably also provide a row of inwardly extending protuberances 24 with surfaces 27 that constrain the member 10 and prevent it from becoming displaced relative to the panel 22 unless the panel itself is removed. Removal is typically accomplished by removing certain fasteners as shown in FIG. 2E. In an alternative embodiment, the perimeter 18 may be supported by shoulders provided solely for the purpose of supporting the member 10.

FIG. 2A is a top view of a second embodiment of a base 30 for use in a container for growing plants. As with the base 10 in FIG. 1A, the base 30 has a central dome 12 and a plurality of channels 16 extending radially from the central dome or hump 12 to a perimeter edge 18. However, the perimeter edge 18 includes protrusions 32.

FIG. 2B is a side view of the base 30 of FIG. 2A illustrating the protrusions 32.

FIG. 2C is a cross-sectional side view of the base 30 of FIGS. 2A and 2B retained to an air-root-pruning panel 42 formed into a sidewall of a container 40. The panel 42 has a plurality of outwardly extending protuberances 44 with openings 46 in the distal end of the protuberances 44. With this type of panel 42, the perimeter 18 of the base 30 is supported on the bottom inside surface 48 of a row of the protuberances 44. As shown, the protrusions 32 will preferably extend into the protuberances 44, thereby constraining the member 30 and prevent it from becoming displaced relative to the panel 42 unless the panel itself is removed. Removal is typically accomplished by removing certain fasteners as shown in FIG. 2E.

FIG. 2D is a partial perspective view of the inner surfaces of the container 40 formed by the base 30 and air-root-pruning panel 42 of FIG. 2C. This perspective view clearly illustrates the engagement of the protrusions 32 around the perimeter 18 of the base 30 with protuberances 44 in a row 50. In this embodiment, engagement of this type would continue around the perimeter 18 of the member 30 so that the panel 42 forms a complete cylindrical sidewall of the container 40 (See FIG. 2C). As shown, the engagement involves a protrusion 32 extending into a protuberance 44 so that the perimeter 18 of the member 30 receives support from the surface 48. The extent to which the protrusion overlaps the surface 48 is not critical, but is preferable greater than 1/8 inch and yet does not block the opening 46 of the protuberance 44. In order to gain the full benefits of air-root-pruning, it is important that the base 30 avoid blocking the openings 46. It should be recognized that the number of protrusions 32 may be fewer than the number of protuberances 44 over the same arch of the perimeter, such that base 30 receives support from fewer than all of the protuberances 32. Still further, the panel 42 may include shoulders, other than the surfaces 48 of the protuberances 44, that extend radially inwardly to support the base 30 without any protrusions at all. Accordingly, the base 30 would then resemble member 10 of FIGS. 1A-C. However, regardless of the system for supporting the base, it is important that the top surface 16 of the member be disposed to direct roots into a row 50 of protuberances 44.

In use, the base 30 is disposed in the bottom of a container below a growth medium so that roots extending downwardly at various angles (shown as arrows 52) contact the surfaces 12, 16. While the roots may also contact the surface of rib 14, the width of this surface is preferably minimized and may be essentially eliminated by giving the rib 14 an upper ridge. FIG. 2D shows seven downwardly extending roots (arrows 52) contacting various portions of the base 30 and two laterally extending roots (arrows 54) directly contacting or extending through the protuberances 44 in the panel 42. When any of the roots (arrows 52 or 54) contact a surface (the point of contact being marked by an “x”), the root is redirected or ricocheted either directly through the channel toward a protuberance 44 or toward a sidewall of the channel that further redirects the roots toward a protuberance. The channels shown here are provided with curved ends 53 (similarly, ribs 14 with flared ends) that assist in guiding roots toward or into an adjacent protuberance. The amount or degree of contact between a container surface and a root is not important, so long as the root is ultimately prevented from circling and, preferably, is air-root-pruned by a protuberance 44.

FIG. 2E is a perspective view of the outer surfaces of the container 40 formed by the base 30 and air-root-pruning panel 42 of FIG. 2C. In this embodiment, the panel 42 is a flexible panel that is bent into a sidewall having a cylindrical shape and securely engaging the base 30. The flexible panel 42 may be secured around the member 30 in various manners, but is shown with fasteners securing overlapping protuberances. It should be recognized that the overlapping protuberances may form a vertical seam (as shown) or a seam at any particular angle. The degree of overlap is not of critical importance, but is shown here having two columns 58 of overlap. Furthermore, the member 30 is shown secured by engagement with protuberances in a second row from the bottom edge 59 of the panel 42, but the member 30 may be equally well secured by any row of the protuberances. This perspective view shows the underneath side of the base 30 which is preferably a concave surface in a manner generally complementary to the preferably convex top surface 16.

FIG. 3 is a schematic side view of a third embodiment of a base 60 for use in a container for growing plants. The base 60 is generally similar to the previously discussed bases 10, 30 in both construction and function with certain special features. First, the base 60 has channels 16 that vary in depth (similarly, ribs 62 that vary in height). Preferably, the channels 16 have a depth 64 at the distal end or region of the channel that is greater than the depth 66 at the proximal end or region of the channel. In fact, the channels do not necessarily extend across the entire diameter of the base or the entire radius of the base. As shown, there is a region 68 where there is no channel. However, if roots are directed outwardly along the channel surface 16 (dashed line) of the base, the roots will pass between adjacent channels sidewalls 62 and, if necessary, the roots will be further directed toward a protuberance in the manner shown in FIG. 2D. The present base 60 also shows an embodiment of the channels 16 having sidewalls 62 with distal ends 69 that terminate without extending into protuberances along with the protrusions 32.

FIG. 4 is a side view of a third embodiment of a base 70 for use in a container for growing plants. The base 70 is generally planar. While this embodiment is less preferred than convex bases, such as the bases 10,30,60, because there is an increased possibility of roots being redirected inwardly, upwardly, or some other disadvantageous direction, the radial channels will still prevent a large degree of root circling that might otherwise occur. It should be recognized that top views of FIGS. 3 and 4 are essentially the same as that of FIG. 2A.

A brief comparison of FIGS. 3 and 4 illustrates another reason that a convex-upward base, such as bases 10, 30 and 60, are preferred over a flat or planar member, such as base 70. The weight of the growth medium, the plant, and moisture retained in the medium pushes downwardly on the base. If the member is reinforced sufficiently, then the member will not bow in the middle. However, it is generally preferred to reduce the thickness of the base and the amount of material used in making the base. The convex shape of the base is more resistant to bowing. Furthermore, any bowing that might occur in a convex member will tend to push the protrusions 32 or perimeter 18 radially outward, thus increasing or improving engagement with the panel 42.

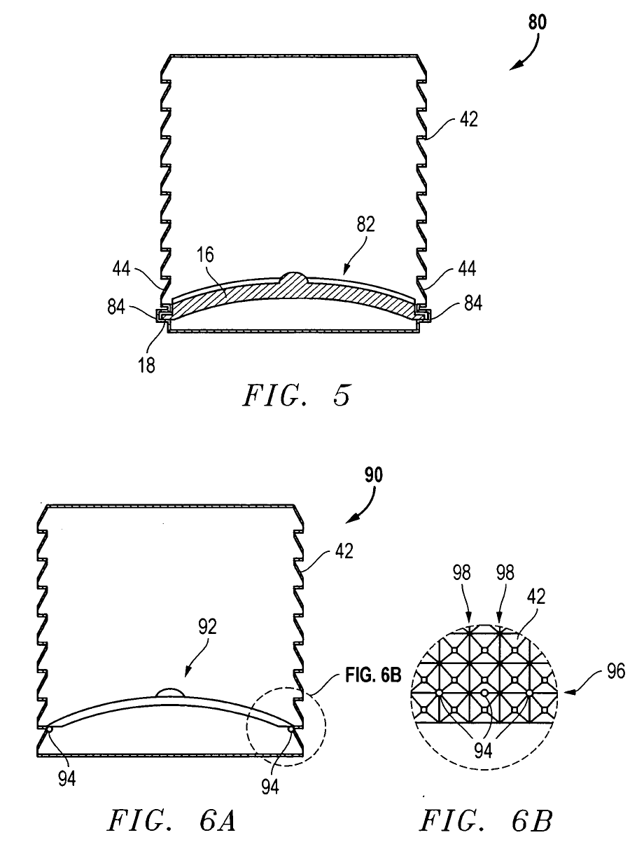

FIG. 5 is a schematic cross-sectional side view of a container 80 having a base 82 retained by special elements 84 formed as part of a flexible panel 42 forming a container sidewall. The special elements 84 are shown as a groove, but may also be a shoulder. Depending upon the configuration of the special element, the perimeter or protrusions are supported thereon. When the special elements 84 do not include air-root-pruning elements, it is preferred that for the surface 16 to align with a portion of the panel 42 that does have air-root-pruning elements, such as protuberances 44.

FIG. 6A is a schematic cross-sectional side view of a container 90 having a base 92, perhaps the same as base 10, that rests upon special elements 94 formed by shoulders or knobs 94 formed as part of the flexible panel 42. Accordingly, it is not necessary, although also not prohibited, for the member 92 to have protrusions that extend into the protuberances. FIG. 6B is an inside face view of a lower section of the panel 42 from FIG. 6A, illustrating the special elements 94 as knobs in a preferred position at discrete points to provide support. While the special elements may form a continuous or semi-continuous shelf, the elements are most preferably discrete knobs 94 that do not interfere with the flexibility of the panel. Furthermore, the elements are preferably disposed in a common plane, most preferably along the line 96 between adjacent rows of protuberances where the panel is not expected to bend much anyway. It should be recognized that much of the panel's flexibility may come from bending at the lines 98 between adjacent columns of protuberances. However, the invention is not limited to panels having such a row and column arrangement. Further still, the knobs 94 may be disposed at various spacing along the panel. Finally, a base may be supported by a protuberance, special elements, or a combination thereof, where the protuberances may project inward, outward or a combination thereof, and where the special elements may be may extend inward, outward or a combination thereof.

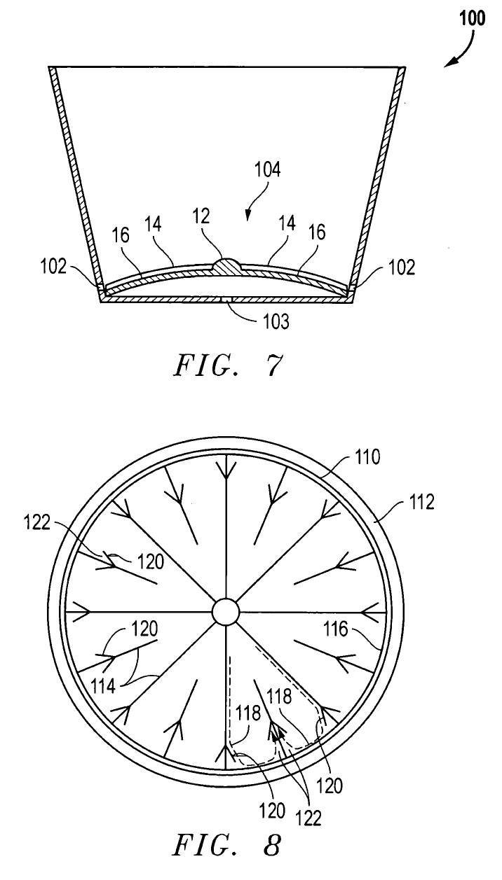

FIG. 7 is a cross-sectional view of a conventional container 100 having drainage holes 102 in the lower side and a further drainage hole 103 in the bottom of the container. The base 104 rests on the bottom of the container. Preferably, the base 104 is configured with channels 16 having sidewalls 14 to prevent or reduce root circling in the bottom of the container. Even more preferably, the channels 16 direct the roots into the drainage holes 102 in the container. It should be recognized that the base could be used in combination with the container 100, as shown, or be formed as part of the original container.

FIG. 8 is a schematic top view of a base 110 for use with a conventional smooth-walled plant container 112. The base 110 rests inside the container 112 along the bottom in the same manner as shown in FIG. 7. However, base 110 has channel sidewalls or ribs 114 (shown schematically) that are designed to work with a smooth-walled container 112 that does not have sufficient apertures to air-root-prune around the perimeter of the container. Rather, the channel sidewalls 114 are configured to work in conjunction with the inside wall 116 of the container 112 to direct roots in a manner that leads to root-tip-trapping.

In use, root tips grow downward into contact with the base 110 and are directed or guided in a radially outward direction shown by dashed lines 118. The exact path of the roots will vary, but the roots will generally be prevented from circling by the channels formed between the sidewalls 114. As the roots extend outwardly along a channel sidwall 114, the roots are turned by a barb, deflector or flare 120 on the channel sidewall 114, preferably near the distal end. The barb 120 directs the root tip toward the container wall 116 at an angle, preferably an angle between about 30 and 60 degree, such that the root will deflect off the wall and into a root-tip-trapping element 122. A preferred root-tip-trapping element 122 is a V-shaped channel formed by the reverse side of the barb 122. Preferably, the channel sidewall 114 will extend very near to the container wall 116 to prevent the roots from circling past the root-tip-trapping element 122 and along the container wall 116. While the barbs 120 and root-tip-trapping elements 122 may be disposed in various configurations, they are preferably formed at the distal end of a channel sidewalls 114. The channel sidewalls 114 may be the same or different from each other. As shown, the channels are formed by an alternating pattern of short and long channel sidewalls 114.

While much of the foregoing discussion has detailed how a base may engage with a panel, the invention encompasses a unitary structure of the two members and a base that may be disposed freely in the bottom of a conventional plant container. It should also be recognized that further structural members or features may be included in the base for the purpose of increasing the strength of the base, reducing the weight or amount of material included in the base, or to improve stacking or storage.

The term “channel” is used herein to mean a “course or passage through which a root may be moved or directed.” The term “base” is used herein to mean “a foundation that supports growth medium for a plant.”

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a base comprising a channel” should be read to describe a base having one or more channels. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. It is intended that this foregoing description is for purposes of illustration only and should not be construed in a limiting sense. Only the language of the following claims should limit the scope of this invention.

1. A plant container, comprising:
a sidewall having a plurality of shoulders; and
a base supported on the shoulders, the base having an upwardly facing surface with a plurality of radially directed channels.

2. The plant container of claim 1, wherein the sidewall and the base are separable.

3. The plant container of claim 2, wherein the sidewall is a flexible panel that is bent and fastened in a closed curvilinear shape.

4. The plant container of claim 3, wherein fastening the panel around the base constrains displacement of the base.

5. The plant container of claim 1, wherein the upwardly facing surface is convex.

6. The plant container of claim 5, wherein the convex surface has a shape selected from conical, semispherical, elliptical, and irregular.

7. The plant container of claim 5, wherein the convex surface has a perimeter and a center that is between 1 and 2 inches higher than the perimeter.

8. The plant container of claim 5, wherein the convex surface has a shape comprising a central arch and a surrounding semispherical region.

9. The plant container of claim 1, wherein the upwardly facing surface has a center and a perimeter, and wherein the channels extend over more than half the distance between the center and the perimeter.

10. The plant container of claim 1, wherein the plurality of shoulders are inwardly extending, outwardly extending, or combinations thereof.

11. The plant container of claim 1, wherein the base has a generally circular perimeter.

12. The plant container of claim 11, wherein the perimeter of the generally circular base has a plurality of projections.

13. The plant container of claim 1, wherein the plurality of shoulders are provided by a plurality of protuberances.

14. The plant container of claim 13, wherein the plurality of protuberances have a proximal opening in communication with a distal opening.

15. The plant container of claim 14, wherein the base has a perimeter with a plurality of projections that extend into the plurality of protuberances through the proximal openings.

16. The apparatus of claim 15, wherein the proximal openings are larger than the distal openings.

17. The plant container of claim 16, wherein the convex face has a shape selected from conical, elliptical, semi-spherical, and irregular.

18. The plant container of claim 16, wherein the convex face has an irregular shape comprising a central arch and a surrounding semi-spherical or frustoconical region.

19. The plant container of claim 16, wherein the channels extend over more than half the distance from the center of the base to the perimeter of the base.

20. The plant container of claim 19, wherein the channels are disposed to direct roots toward the plurality of protuberances.

21. The plant container of claim 20, wherein each channel has a sidewall that directs roots toward an individual protuberance.

22. The plant container of claim 20, wherein the channels extend into the proximal openings of the protuberances.

23. The plant container of claim 21, wherein the channels have a distal end with a deflecting curve.

24. The plant container of claim 21, wherein the individual protuberance is one of the plurality of protuberances that provide the plurality of shoulders.

25. The plant container of claim 21, wherein the individual protuberance is not one of the plurality of protuberances that provide the plurality of shoulders.

26. The plant container of claim 1, wherein the channels are between 0.1 and 1 inches tall.

27. The plant container of claim 1, wherein the channels are between 0.15 and 0.75 inches tall.

28. The plant container of claim 1, wherein the channels are between 0.25 and 0.5 inches tall.

29. The plant container of claim 1, further comprising a central dome directing roots outwardly.

30. The plant container of claim 1, wherein the channels are taller at a distal end than at a proximal end

31. The plant container of claim 13, wherein the center of the proximal opening is positioned higher than the center of the distal opening when the panel is positioned upright.

32. The plant container of claim 31, wherein the perimeter of the base has a plurality of projections that extend into the plurality of protuberances through the proximal opening.

33. The plant container of claim 31, wherein the convex face has a shape selected from conical, elliptical, semi-spherical, irregular, and combinations thereof.

34. The plant container of claim 31, wherein the convex face has an irregular shape comprising a central arch and a surrounding frustoconical or semi-spherical region.

35. The plant container of claim 31, wherein the channels extend over more than half the distance from the center of the base to the perimeter of the base.

36. The plant container of claim 29, wherein the channels are disposed to direct roots toward the plurality of protuberances.

37. The plant container of claim 36, wherein each channel has a sidewall that directs roots toward an individual protuberance.

38. The plant container of claim 37, wherein the individual protuberance is one of the plurality of protuberances that provide the plurality of shoulders.

39. The plant container of claim 37, wherein the individual protuberance is not one of the plurality of protuberances that provide the plurality of shoulders.

40. The plant container of claim 37, wherein the plurality of protuberances have a lower profile with a substantially horizontal region that receives the projections.

41. The plant container of claim 40, wherein the proximal opening is larger than the distal opening.

42. The plant container of claim 13, wherein the plurality of protuberances extend inward.

43. The plant container of claim 42, wherein the sidewall further comprises a plurality of outwardly extending protuberances having a proximal opening in communication with a distal opening.

44. The plant container of claim 43, wherein the perimeter of the base has a plurality of projections that extend into the plurality of outwardly extending protuberances through the proximal opening.

45. The plant container of claim 44, wherein the channels are disposed to direct roots toward the plurality of protuberances.

46. The plant container of claim 45, wherein each channel has a sidewall that directs roots toward an individual protuberance.

47. The plant container of claim 46, wherein the individual protuberance is one of the plurality of protuberances that provide the plurality of shoulders.

48. The plant container of claim 46, wherein the individual protuberance is not one of the plurality of protuberances that provide the plurality of shoulders.

49. The plant container of claim 43, wherein the convex face has a shape selected from conical, elliptical, semi-spherical, irregular, and combinations thereof.

50. The plant container of claim 43, wherein the convex face has an irregular shape comprising a central arch and a surrounding frustoconical region.

51. The plant container of claim 43, wherein the channels extend over more than half the distance from the center of the base to the perimeter of the base.

52. A plant container, comprising:
a base having an upwardly facing convex surface with a plurality of radially directed channels; and
a container sidewall extending upward around the perimeter of the base, wherein the sidewall includes a hole adjacent the plurality of radially-directed channels.

53. The plant container of claim 52, wherein the convex surface comprises a central arch and a surrounding frustoconical or semi-spherical region.

54. The plant container of claim 52, wherein the channels extend over more than half the distance from the center of the base to the perimeter of the base.

55. The plant container of claim 52, wherein the channels have a distal end with a deflecting curve.

56. The plant container of claim 52, wherein the channels extend above the surface by between 0.1 and 1 inches.

57. A base for inserting in a plant container, comprising:
a base having an upwardly facing surface including a plurality of radially directed channels, a deflecting element near a distal end of each channel, and a root-tip-trapping element, wherein the deflecting element directs roots against a wall of the container at an angle that causes the root to deflect off the wall and into the root-tip-trapping element.

58. The plant container of claim 57, wherein the upwardly facing surface is convex.

59. The plant container of claim 58, wherein the convex surface has a shape selected from conical, semispherical, elliptical, and irregular.

60. A plant container, comprising:
a container sidewall; and
a base secured to the container sidewall, the base having an upwardly facing surface with a plurality of radially directed channels.

61. The plant container of claim 60, wherein the base has protrusions received within recesses in the container sidewall.

62. The plant container of claim 60, wherein the channels are substantially free from obstructions to radial root growth.

63. The plant container of claim 60, wherein the plurality of channels include at least eight channels.

64. The plant container of claim 60, wherein the container sidewall comprises protuberances and the channels are directed toward the protuberances.
